(19) United States
(12) Patent Application Publication
(10) Pub. No.: US 2005/0117841 A1
(43) Pub. Date: Jun. 2, 2005

(54) Optical array for generating a broadband spectrum

(76) Inventors: Bernd Braun, Jena (DE); Guenter Hollemann, Jena (DE)

Correspondence Address: JORDAN AND HAMBURG LLP, 122 EAST 42ND STREET, SUITE 4000, NEW YORK, NY, 10168, US

(21) Appl. No.: 10/514,051

(22) PCT Filed: May 7, 2003
(86) PCT No.: PCT/DE03/01482

(30) Foreign Application Priority Data
May 5, 2000 (GB) 0010950.4

(51) Int. Cl. G02B 6/26

(52) U.S. Cl. 385/27

(57) ABSTRACT

Disclosed is an optical array for generating a broadband spectrum. The aim of the invention is to reduce the technical complexity of said optical array while keeping the source of laser radiation compact and adjusting in a simple manner the wavelength range of the broadband spectrum to the sensitivity range of conventional semiconductor detectors. Said aim is achieved by coupling in an optically adapted manner a passively mode-coupled solid body laser which supplies picosecond impulses having an initial wavelength that lies within the infrared range to a photonic fiber. A radiation performance interval of the broadband spectrum, which is maintained at an essentially steady intensity, is set within a wavelength range of 700 nm to 1000 nm below the initial wavelength by adjusting the dispersion of said photonic fiber to the initial wavelength. The broadband source of radiation is highly brilliant and can be used in white light interferometry (OCT, coherence radar, spectral radar) and in spectroscopy (pump-probe spectroscopy), among others.

The invention relates to an optical arrangement for generating a broadband spectrum that can be used as a broadband radiation source with high brilliance, e.g., in white light interferometry (OCT, coherence radar, spectral radar) and spectroscopy (pump-probe spectroscopy).

As is known, in such radiation sources intensive light pulses pass through a non-linear optical medium so that through non-linear optical processes substantial spectral broadening occurs and a so-called supercontinuum is generated.

Of the various known media in which such spectral broadenings can occur, recently so-called photonic crystal fibers (PCF) have enjoyed increased interest among specialists in this field. These fibers comprise a quartz core that is surrounded by a series of microscopic air-filled or gas-filled hollow spaces that run along the length of the fiber so that a honeycomb fiber structure occurs in the fiber cross-section. Using the size and arrangement of the hole structure, the radiation can be concentrated on a very small area, which can lead to the non-linear optical processes.

Thus it has been demonstrated many times that PCFs are ideal media for generating a supercontinuum. Stimulated Raman scattering, self-phase and cross-phase modulation, and parametric four-wave mixing were recognized as primarily supporting processes. But soliton effects, non-linear effects of higher order, and dispersion can play a role.

Initially, particular interest focused on generating the continuum from femtosecond laser pulses that have sufficiently high field intensities for activating non-linear optical processes in the fibers used. Experiments were performed, e.g., by:

Ranka, Windeler, Stentz, “Visible continuum generation in air-silica microstructure optical fibers with anomalous dispersion at 800 nm”, Opt. Lett. 25, 25 (2000);

Hartl, Li, Chudoba, Ghanta; Ko, Fujimoto, “Ultrahigh-resolution optical coherence tomography using continuum generation in an air-silica microstructure optical fiber”, Opt. Lett. 26, 608 (2001); and,

Holzwarth, Zimmermann, Udem, Hänsch, et. al., “White-light frequency comb generation with a diode-pumped Cr:LiSAF laser”, Opt. Lett. 26, 1376 (2001).

In S. Coen, A. H. L. Chan, R. Leonhardt, J. D. Harvey, J. C. Knight, W. J. Wadsworth, P. St. J. Russell, “White-light supercontinuum generation with 60-ps pump pulses in a photonic crystal fiber”, Optics Letters 26 1356 (2001), it was demonstrated that a spectrum broadened bilaterally to the wavelength of the pump radiation source (677 nm) can also be generated with ps pulses.

All of the solutions known previously for generating a supercontinuum are complex in structure and thus are large and maintenance- and cost-intensive.

This is particularly disadvantageous when a compact broadband radiation source with high brilliance is required, such as e.g. for white light interferometry (OCT, coherence radar, spectral radar) and spectrometry (pump-probe spectroscopy).

In addition, an optimum signal-to-noise ratio demands spectral distribution of the light, adapted to the spectral sensitivity of conventional semiconductor detectors.

The object of the invention is therefore to reduce the complexity for generating a broadband spectrum in that the laser radiation source required for this is kept compact and the wavelength range of the broadband spectrum is adapted in a simple manner to the sensitivity range of conventional semiconductor detectors.

This object is achieved with an optical arrangement for generating a broadband spectrum in which a passive mode-coupled solid-state laser optically adapted for providing picosecond pulses with an output wavelength in the infrared range is coupled to a photon fiber, and its dispersion adaptation to the output wavelength results in a radiation power interval of the broadband spectrum, which radiation power interval runs largely with uniform intensity in a wavelength range of 700 nm-1000 nm below the output wavelength.

Although there is no complicated prior frequency conversion, the radiation power interval running largely with uniform intensity can be placed in a range from 700 nm-1000 nm with the present invention.

The picosecond solid-state laser used, which itself is substantially more simple in its construction and thus also more cost effective than the laser used in the prior art for generating a supercontinuum, is largely distinguished however in that acting as active medium is an anisotropic laser crystal that is pumped by an asymmetrical pump beam, the pump beam cross-section of which has different expansions perpendicular to one another and which is interspersed by a laser beam cross-section adapted to this asymmetry with an axis relationship in directions running perpendicular to one another that is greater than 1:1 and less than 1:3.

Of the crystallographic axes of the anisotropic laser crystal, the axis in the direction of which the crystal breaking point is highest is oriented along the greatest temperature gradients in the direction of the lower expansion of the pump beam cross-section.

The anisotropic laser crystal, which contains a crystal cross-section interspersed by the pump beam and with pairs of parallel opposing crystal edges of different edge lengths, at least in one partial section of the laser crystal, has its greatest thermal expansion coefficient in the direction of the lower expansion of the pump beam cross-section and parallel to the crystal edge with the shorter edge length.

While partially maintaining a defined asymmetry for achieving a high pump power density, for adapting the laser beam to this asymmetry, the laser crystal is oriented to this asymmetry in an entirely novel manner. The asymmetry of the heat flow, caused by the reduction in the crystal dimensions in the direction of the lower expansion of the pump beam cross-section, and the resultant asymmetry of the thermal lens in directions that run perpendicular to one another, can be adapted at the resonator such that in the interior of the crystal an asymmetrical laser mode is realized that is adapted to the asymmetrical pump mode, without additional astigmatic elements being required in the resonator, i.e., without having to employ different beam shaping means for the different axes.

In addition, it was also found that particularly favorable thermoelastic properties, in the form of enhanced breaking strength properties, are linked to the orientation measures and the design of the laser crystal, it thus being possible to adapt the laser crystal to receiving high pump power densities. In addition, significantly enhanced temperature ratios in the center of the anisotropic laser crystals can be attained. In particular, decreasing the maximum temperature there has a positive effect on enhancing the efficiency of the laser transition due to lower thermal loading.

The asymmetrical thermal lens is used for generating the elliptical laser beam cross-section with the axis ratio greater than 1:1 and less than 1:3. Using a Brewster cut beam exit surface of the laser crystal, this axis ratio can be increased by the factor of the ratio of the refraction index of the laser crystal to the refraction index of the air.

The invention provides a cost-effective, compact broadband radiation source that can be used for a variety of purposes and that is distinguished by an efficient and simply constructed laser. Using the frequency conversion element adapted especially to the output wavelength, a significant broadening of the laser bandwidth with the main portion in the range of between 700 nm and 1000 nm and with largely uniform intensity can be attained, although the output wavelength, at 1064 nm, is longer.

The invention is explained in greater detail in the following using the drawings.

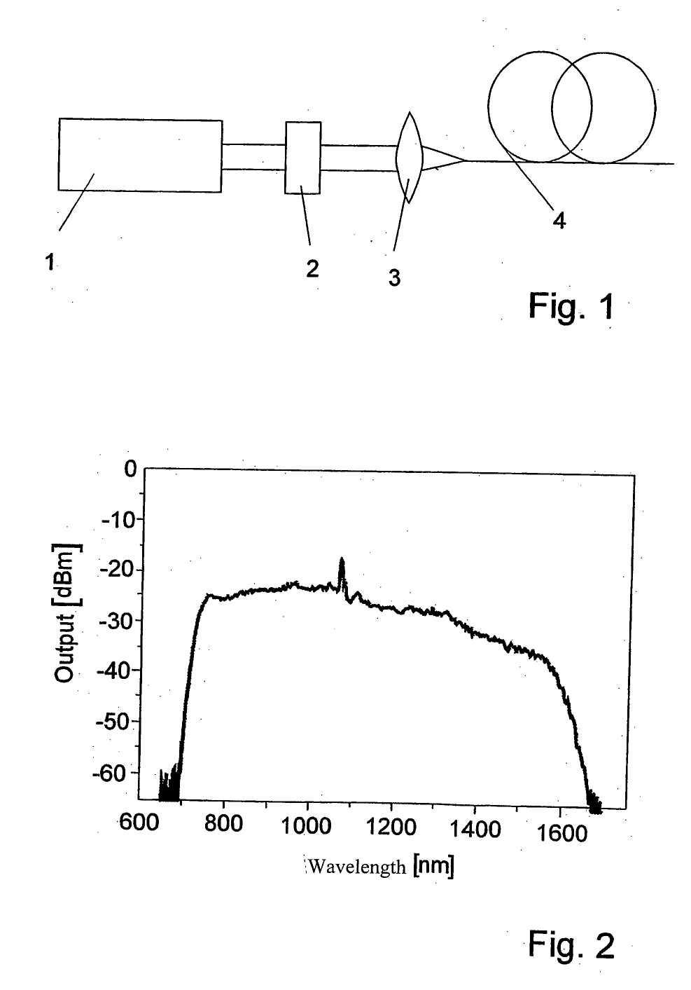

FIG. 1 illustrates an optical arrangement for a compact picosecond broadband radiation source;

FIG. 2 illustrates a supercontinuum spectrum of the picosecond broadband radiation source in accordance with FIG. 1;

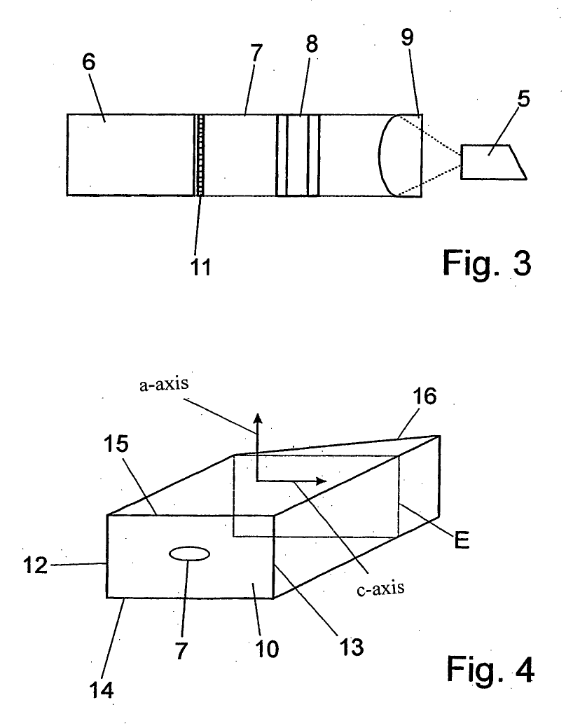

FIG. 3 illustrates a pump arrangement for a mode-coupled solid-state laser;

FIG. 4 illustrates the axis orientation in the anisotropic laser crystal.

The broadband radiation source in accordance with FIG. 1 comprises a passive mode-coupled solid-state laser 1 that includes a mode-coupled resonator, working with saturable semiconductor absorbers, with three deviation mirrors and one final mirror and that is protected from feedback by an optical insulator 2 and that is coupled via coupling optics 3 to a frequency conversion element in the form of a photonic crystal fiber 4.

The solid-state laser 1, which has a mean output power of 6 W, delivers laser pulses at an output wavelength in the infrared range of 1=1064 nm and pulse durations of 8.5 ps whose spectral bandwidth is 0.27 nm. The present exemplary embodiment furthermore works at a pulse repetition rate of 120 MHz, a mean pulse energy of 50 nJ, and a mean pulse peak power of 5.8 kW. The output radiation is horizontally linearly polarized and the beam quality is M2=1.

As an optical diode, the optical insulator specified for the output wavelength prevents back-reflected or back-scattered radiation from the coupling optics 3 and the photonic crystal fiber 4 from being fed back into the resonator of the solid-state laser 1, which would lead to sensitive interference of the mode coupling operation.

With the coupling optics 3, for which an aspherical glass lens with a focal length of f=4.5 mm, a numeric aperture of NA=0.55, and an antireflex coating is used, beam focusing achieves a best possible adaptation of the free beam parameters (beam radius and beam angle of the Gaussian beam, TEM00 of the solid-state laser 1) to the parameters of the fiber modes and thus a maximum power coupling into the photonic crystal fiber 4 (maximum coupling efficiency 49.6%). In this manner excitation of certain fiber modes with low magnitude can be achieved.

The five-meter long photonic crystal fiber 4 with a core diameter of 5 mm, a numeric aperture of NA=0.21, is dispersion adapted for the output wavelength and facilitates the spectral broadening of the spectral bandwidth of the laser pulses, whereby this is achieved by very different optical non-linear effects with varying characteristics, e.g., by stimulated Raman scattering, self-phase and cross-phase modulation, parametric four-wave mixing, soliton effects, dispersion, and non-linear effects of higher magnitude. In particular the fiber 4 is adapted to the output wavelength such that the monochromatic infrared laser radiation of 1064 nm is converted into spectral broadband radiation also in the shorter-wave NIR/VIS range, that is, a range in which semiconductor detector elements are sensitive.

As can be seen from FIG. 2, the inventive arrangement generates a broadband spectrum in which a radiation power interval encompassing more than 40% of the radiation power is in a range of 700 nm-1000 nm. Of particular significance for the provided application areas is the largely uniform intensity in the large wavelength range below the output wavelength, while above it a drop in power is recorded.

In contrast to the solutions provided by the prior art, the broadband radiation source that provides this spectrum has a particularly simple and loadable structure, in particular with respect to the solid-state laser 1. This is pumped directly by a diode laser, a pump arrangement being provided that permits a particularly high pump power density without destroying the laser crystal.

For final pumping of a laser crystal 5, the pump arrangement illustrated in FIG. 3 contains a pump radiation source 6 in the form of a laser diode bar or an arrangement thereof, whose pump beam 7 is directed focused by means of two cylinder lenses 8 and 9 on a beam entry surface 10 of the laser crystal 5. When it enters the laser crystal 5, the pump beam 7 is asymmetrical in its cross-section with different expansions perpendicular to one another.

For achieving a high pump beam density, it has proved advantageous for enhancing beam properties of the laser diode bar to collimate the slow axis in a particular manner in addition to collimating the fast axis in a particular manner. The individual emitters arranged in the laser diode bar in lines normally take up only part of the available space. The other part is occupied by intermediate areas, so-called “spacings”, that have a negative effect on the beam parameter product, since the radiating surface is enlarged by the unused space in the intermediate area. Arranging collimation lenses in the plane of intersection of the laser beam bundle eliminates the destructive interference, which can improve the beam parameter product by approximately a factor of 2. The microoptics 11 provided for this are arranged downstream of the pump beam source 2 for this purpose.

In accordance with FIG. 4, the anisotropic laser crystal 5, for which an Nd:YVO4 crystal that is 4×2×6.9 mm³ in size is used, is oriented to the pump beam such that its crystallographic c-axis is oriented in the direction of greater expansion (parallel to the slow axis) and the crystallographic a-axis, in whose direction is the highest value of the crystal breaking point and of the thermal expansion coefficient, is oriented in the direction of the lower expansion of the pump beam cross-section (parallel to the fast axis).

If in addition the crystal height in the direction of the a-axis is reduced and thus the temperature gradient is further increased, it has been demonstrated that this results in a substantial increase in the crystal strength in terms of thermal load. This means that the laser crystal 5 can be operated at substantially higher pump powers and pump power densities.

For this reason, the laser crystal 5 has a crystal diameter interspersed by the pump beam 7 with pairs of parallel opposing crystal edges 12, 13, 14, and 15 of different edge lengths, the crystal edges 12 and 13 having a shorter edge length than the crystal edges 14 and 15 and running in the direction of the lower expansion of the pump beam cross-section.

The preferred edge ratio is of course present in a Brewster cut laser crystal only in a partial section that begins at the beam entry surface 10 and terminates at a plane E, after which the Brewster surface 16, which is inclined against the resonator beam and which acts as beam exit surface, reduces the cross-section surface and thus also changes the edge ratio.

The elliptical mode cross-section of the laser beam, which is generated using the asymmetrical thermal lens and by the Brewster cut of the laser crystal 1, thus has an axis ratio or 1:2 to 1:3.

1-6. (canceled)

7. An optical arrangement for generating a broadband spectrum comprising:
a passive mode-coupled solid-state laser, said laser providing picosecond pulsed laser beams having an output wavelength in the infrared range;
a photon fiber, said fiber coupled to said laser, said fiber having a dispersion characteristic adapted to said laser beam output wavelength; and
said laser beam provides a broadband uniform radiation power interval having a wavelength range of 700 nm-1000 nm below said laser beam output wavelength.

8. The optical arrangement of claim 1, wherein said solid-state laser further comprises an active medium being an anisotropic laser crystal;
said crystal being pumped by an asymmetrical pump beam having mutually perpendicular cross sectional axes, said cross sectional axes having a ratio greater than 1:1 and less than 1:3;
said laser beam having a cross sectional axis ratio, said laser beam cross sectional ratio defined by said pump beam cross sectional ratio, said pump beam being interspersed by said laser beam; and
said cross-section of said pump beam having mutually perpendicular expansions parallel to said axes.

9. The optical arrangement of claim 8, wherein said expansions include a lower expansion; and
said anisotropic laser crystal having a crystallographic axis in a direction of the highest value of the crystal breaking point, said axis being along a greatest temperature gradient of said crystal, and said axis being along said lower expansion of said pump beam cross-section.

10. The optical arrangement of claim 8, wherein said expansions include a lower expansion; and
said anisotropic laser crystal having pairs of parallel opposing crystal edges of different edge lengths, said laser crystal having a thermal expansion coefficient being larger in said direction of lower expansion of the pump beam cross-section and parallel to a crystal edge with a shorter edge length.

11. The optical arrangement of claim 10 further comprising an asymmetrical thermal lens embodied laser crystal, said lens having different thicknesses in mutually perpendicular directions, whereby the thickness of said thermal lens is defined by the size of said expansion of said pump beam cross-section.

12. The optical arrangement of claim 11, wherein said axis ratio in said laser beam cross-section is obtained from said different thicknesses of said thermal lens.
